(19) United States
(12) Patent Application Publication
(10) Pub. No.: US 2023/0243073 A1
(43) Pub. Date: Aug. 3, 2023

(54) TUBULAR WOVEN LINER

(71) Applicant: SANEXEN ENVIRONMENTAL SERVICES INC., Brossard (CA)

(72) Inventors: Sylvain MORISSETTE, Sherbrooke (CA); Joël HÉRAUD, Sherbrooke (CA); Martin BUREAU, Montreal (CA); Sébastien CARRIER, Coaticook (CA); Pascal MICHAUD, St-Hermenegilde (CA)

(21) Appl. No.: 18/002,933

(22) PCT Filed: Aug. 6, 2021
(86) PCT No.: PCT/CA2021/051095

§ 371 Date: Dec. 22, 2022

Related U.S. Application Data
(60) Provisional application No. 63/071,242, filed on Aug. 27, 2020.

(51) Int. Cl. D03D 3/02; D03D 11/00; D03D 15/283

(52) U.S. Cl. CPC D03D 3/02; D03D 11/00; D03D 15/283; F16L 11/02

(57) ABSTRACT

A woven tubular liner comprising an outer surface comprising outer wefts and warps and an inner surface comprising inner wefts and the warps, wherein the inner and outer surfaces are connected by the warps, the outer wefts being protected from an environment inside of the tubular linear and the inner wefts being protected from an environment outside of the tubular liner. The method comprises repeating a weaving unit of continuous outer wefts and continuous inner wefts running uninterrupted along a circumferential direction, woven with continuous warps running along a longitudinal direction, offsetting positions of the warps relative to the wefts in the weaving unit, selectively interlacing outer wefts with the warps, and selectively interlacing inner wefts with the warps.

### FIELD OF THE INVENTION

The present invention relates to tubular liners. More specifically, the present invention is concerned with woven tubular liners.

### BACKGROUND OF THE INVENTION

Compared to flat fabric weaving, which is used to manufacture flat liners, in circular weaving of wefts and warps, the wefts and the warps are continuous, i. e. running uninterrupted along a circumferential direction, and along a longitudinal direction respectively, and the weft yarns are submitted to reduced displacement during weaving. Interestingly, continuously woven tubular products have fewer points of weakness than tubular products assembled from flat liners when stressed at high pressure for example.

Still, during circular weaving, typically displacement of the different yarns by the shuttle occurs, in all directions. As a result, the resulting woven structures may be too loose and not be strong enough depending on applications, for example under high pressure, and/or in applications where the tubular products need to respond quickly and without incident such as bunching or accumulation of internal sheath. High flow hoses used to move large bodies of water or for rehabilitation of waterways and filtration, and flexible industrial pipes used in agriculture, for example are all tubular products submitted to high forces.

Tubular liners are used in a number of applications, such as fire hoses for example. The properties required for a fire hose for example often require a doubled structure. Obtaining a double structure by circular weaving is still a challenge.

Double jacket hoses comprise two separate sheaths inserted one into the other. Upon use one sheath may stretch more than the other sheath, the less stretched sheath creating wrinkles in the assembly; such so-called “bunching” may be internal or external, as the accumulation of wrinkles may occur to a different degree on the inner or on the outer sheath, respectively.

There is still a need in the art for tubular woven liners.

### SUMMARY OF THE INVENTION

More specifically, in accordance with the present invention, there is provided a woven tubular liner, comprising an outer surface and an inner surface, wherein the outer surface comprises outer wefts and warps, and the inner surface comprises inner wefts and the warps, the inner and outer surfaces being connected by the warps, the outer wefts being protected from an environment inside of the tubular linear and the inner wefts being protected from an environment outside of the tubular liner.

There is further provided a tubular liner weaved of continuous warps and continuous wefts, comprising at least i) first wefts interlaced with the warps and ii) second wefts interlaced with the warps, the first wefts interlaced with the warps and the second wefts interlaced with the warps being connected by the warps, and the first and the second wefts being separated.

There is further provided a method of weaving a tubular liner, comprising repeating a weaving unit of continuous outer wefts and continuous inner wefts running uninterrupted along a circumferential direction, woven with continuous warps running along a longitudinal direction, offsetting positions of the warps relative to the wefts in the weaving unit, selectively interlacing outer wefts with the warps, and selectively interlacing inner wefts with the warps.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1A shows movement and relative positions of warps (stippled lines), in relation to wefts, over a sequence of rotations of the shuttle of the weaving machine for a weave of a tubular woven liner according to an embodiment of an aspect of the present disclosure, with full dots representing outside wefts and circles representing inside wefts;

FIG. 1B shows the outer surface of the resulting fabric of the woven tubular liner, with dark squares representing outside wefts (Tout) and the lighter squares (C) representing warps;

FIG. 1C shows a middle or median plane of the fabric, with darker squares representing outside wefts, and lighter squares of two shades representing inside wefts (Tin) and warps (C) respectively;

FIG. 1D shows the inner surface of the resulting fabric of the woven tubular liner, with darker squares representing inside wefts (Tin) and lighter squares representing warps (C);

FIG. 2 shows movement and relative positions of the warps, in relation to wefts, corresponding to FIG. 1;

FIG. 3A shows movement and relative positions of warps (stippled lines), in relation to wefts, over a sequence of rotations of the shuttle of the weaving machine for a weave of a tubular woven liner according to an embodiment of an aspect of the present disclosure, with full dots representing outside wefts (Tout) and circles representing inside wefts (Tin);

FIG. 3B shows the outer surface of the resulting fabric of the woven tubular liner, with dark squares representing outside wefts (Tout) and the lighter squares representing warps (C);

FIG. 3C shows a middle or median plane of the fabric, with darker squares representing outside wefts (Tout), and lighter squares of two shades representing inside wefts (Tin) and warps (C) respectively;

FIG. 3D shows the inner surface of the resulting fabric of the woven tubular liner, with darker squares representing inside wefts (Tin) and lighter squares representing warps (C);

FIG. 4A shows the outer surface of the fabric of the tubular liner of FIG. 3;

FIG. 4B shows the inner surface of the fabric of the tubular liner of FIG. 3;

FIG. 4C is a circumferential cross section of the fabric of the tubular liner of FIG. 3;

FIG. 4D is a longitudinal cross section of the tubular liner of FIG. 3;

FIG. 5 is a graph of elongation of tubular liners as a function of inner pressure;

FIG. 6 shows results of burst tests of tubular liners; and

FIG. 7 shows results of expansion tests of tubular liners.

### DESCRIPTION OF ILLUSTRATIVE EMBODIMENTS

The present invention is illustrated in further details by the following non-limiting examples.

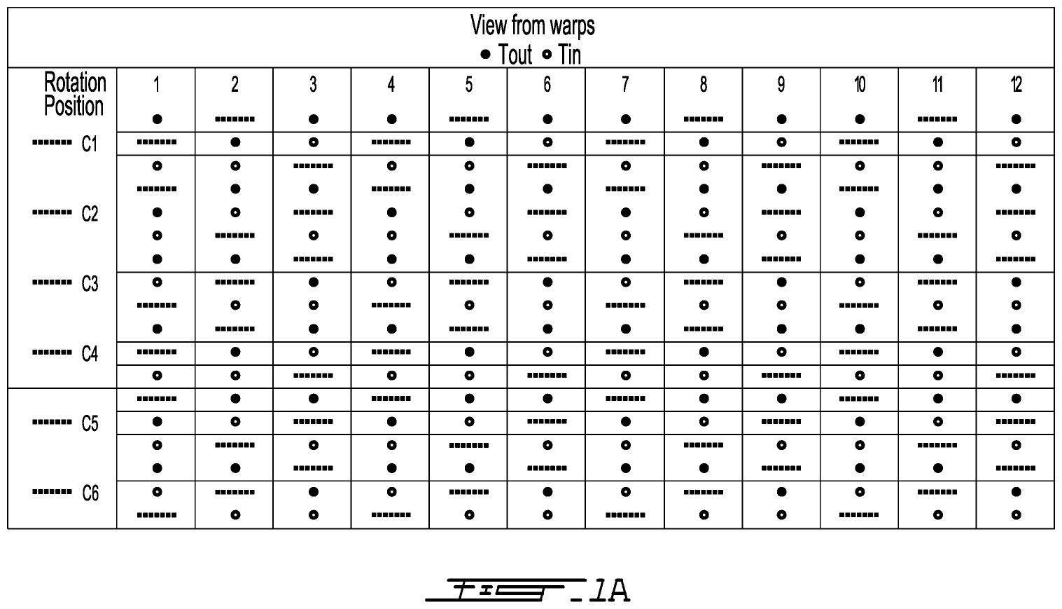

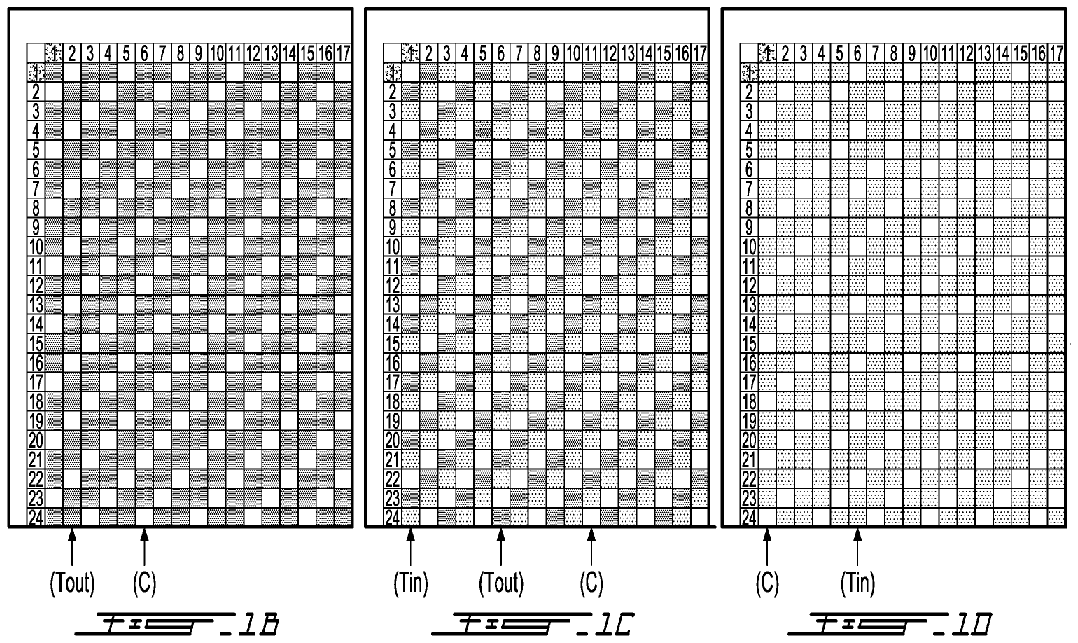

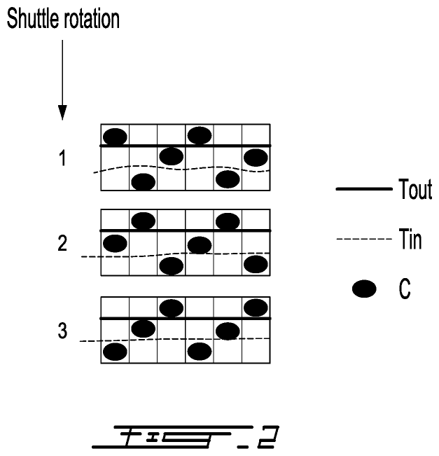

FIG. 1A shows the movement of three parallel warps C1, C2, C3 (repeated C4, C5, C6) out of a total number of parallel warps running along the longitudinal direction, in relation to outer and inner wefts Tout, Tin, over a sequence of 12 rotations of the shuttle of the weaving machine, for a tubular woven liner of an embodiment of an aspect of the present disclosure. The parallel warps are offset in position relative to the wefts Tin, Tout.

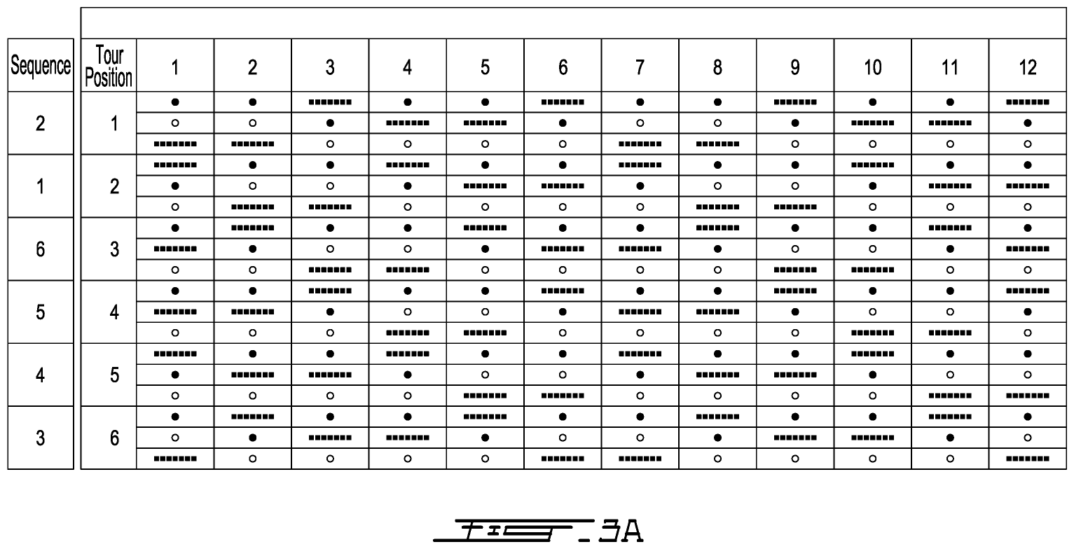

FIG. 2 shows corresponding positions of the wefts Tout, Tin, relative to the parallel warps C1, C2, C3, over the 3 shuttle rotations (1, 2, 3), which is a repeated sequence.

With the outer weft Tout in an upper position while warp C1 is in a middle position and the inner weft Tin is in a lower position over rotation 1, then on 6 rotations for example, the outer weft Tout travels between the upper position and the middle position while the inner weft Tin runs from the low position to the middle position, the warp C1 running through the 3 positions. Thus, the warp C1 ends up interlocked by the inner weft Tin and the outer weft Tout, and the inner weft Tin and the outer weft Tout found themselves connected together through the warp C1 (See FIG. 1C).

As a result, the outer surface of the fabric, facing the outer environment, of the resulting tubular liner is formed by the outer wefts Tout and the warps (C) (FIG. 1B), while its inner surface, facing the inside of the tubular liner, is formed by the inner wefts Tin and the warps (C) (FIG. 1D), the outer wefts Tout not taking part of the inner surface of the fabric and thereby remaining protected from the environment inside of the tubular liner, and the inner wefts Tin not taking part of the outer surface of the fabric, thereby remaining protected from the outer environment.

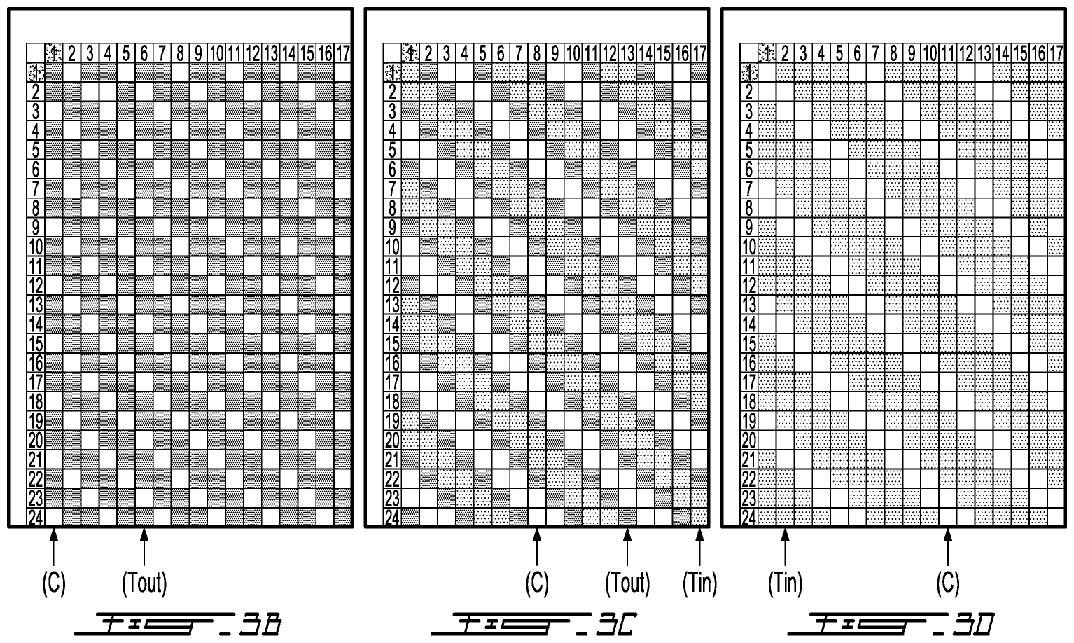

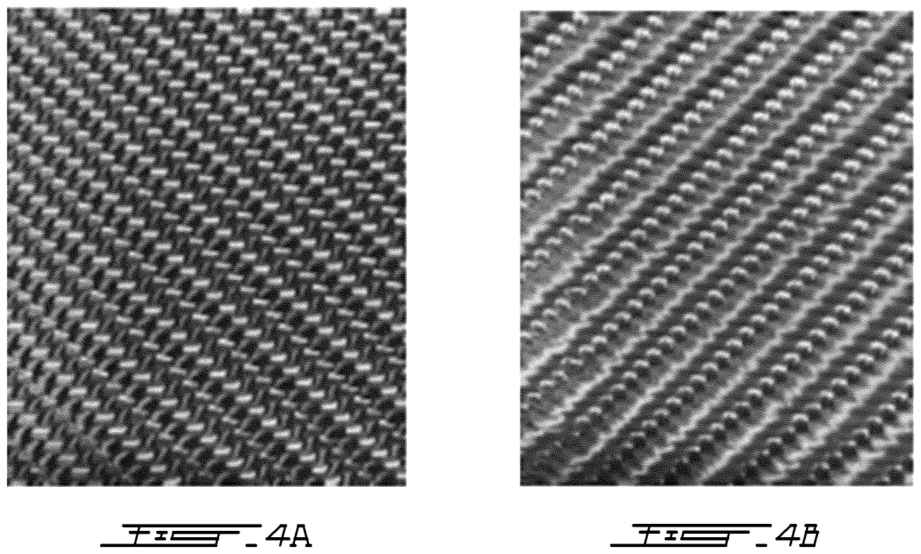

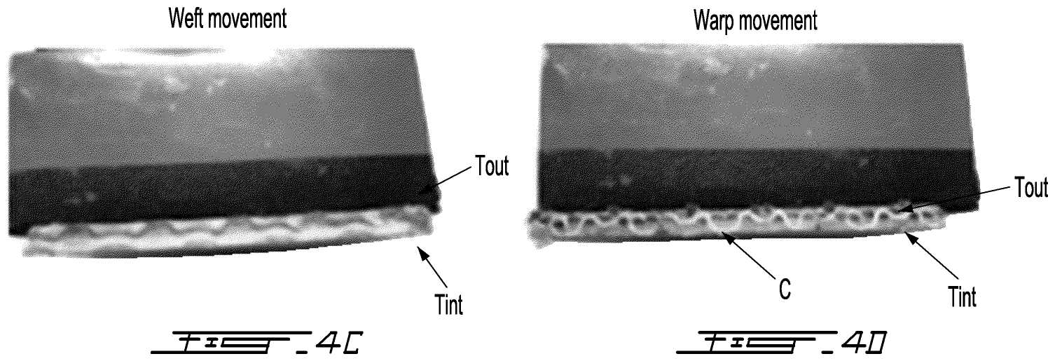

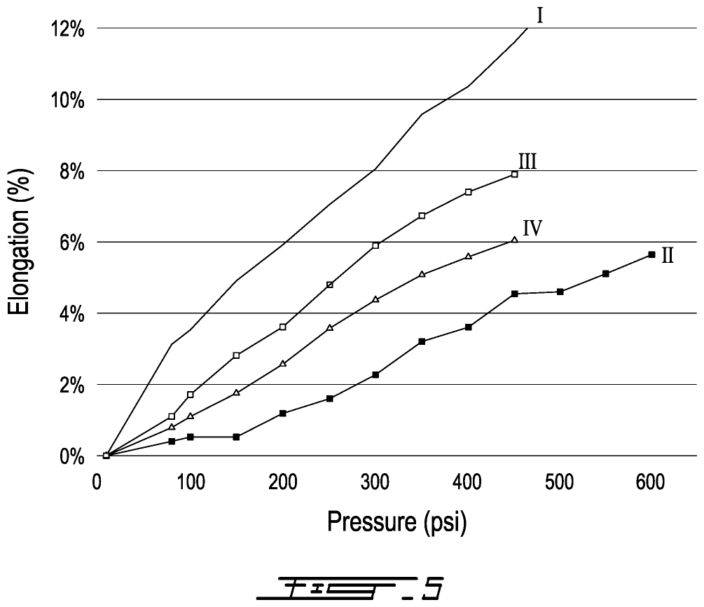

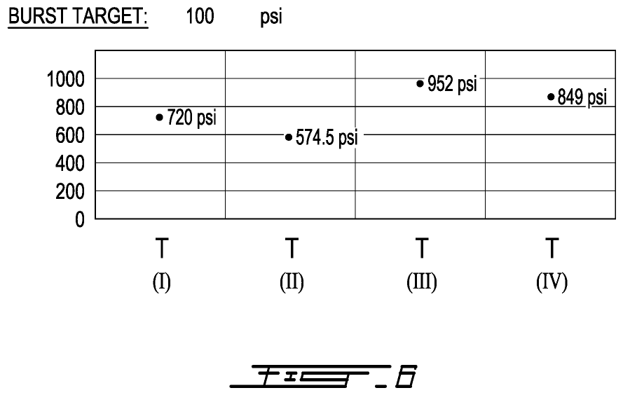

FIGS. 3 and 4 show another embodiment of the present disclosure, in which successive warp positions generate interlacing of the inner and outer wefts such that the outer wefts Tout engage the upper position and the middle position of the warps, while the inner wefts Tin engage the lower position and the middle position of the warps. Thus the warps are interlocked by both the inner and the outer wefts in the middle position, while the warps are interlocked with the inner wefts Tin only in the lower position and the warps are interlocked with the outer wefts Tout only in the upper position.

As a result, the outer surface of the fabric, facing the outer environment of the resulting tubular liner, is formed by the outer wefts Tout and the warps (C) (FIG. 1B) while its inner surface, facing the inside of the tubular liner, is formed by the inner wefts Tin and the warps (C) (FIG. 1D), the outer wefts Tout not taking part of the inner surface of the fabric and thereby remaining protected from the inside of the tubular liner and the inner wefts Tin not taking part of the outer surface of the fabric, thereby remaining protected from the outer environment.

Thus, the inner and outer surfaces of the tubular liner are physically separated and not interlocked directly with one another, still connected together in an integral wall structure. The present disclosure thus provides a single layer woven tubular liner, allowing features of double jacket tubular liners while overcoming issues of differential stretching of double jacket tubular liners upon use causing wrinkles or bunching.

A method of weaving a tubular woven liner according to an embodiment of an aspect of the present disclosure comprises repeating a weaving unit of continuous outer and inner wefts running uninterrupted along the circumferential direction, with continuous warps running uninterrupted along the longitudinal direction. The method comprises offsetting the positions of the warps relative to the wefts in the weaving unit, selectively interlacing the outer wefts with warps, and selectively interlacing the inner wefts with warps. As a result, in the thickness of the fabric of the resulting tubular liner, the outer wefts and the inner wefts are separated, each in a separate level of the structure, namely a level comprising outer wefts and warps, and a level comprising inner wefts and warps.

The method comprises separating the outer and inner wefts of the weave by the warps. As a result the first surface of the tubular liner is formed by the inner wefts interlocked with the warps, while the second surface of the tubular liner is formed by the outer wefts interlocked with the warps. Thus, although the tubular liner is a single jacket tubular liner, the inner and outer surfaces of the tubular liner are separated and they do not share the inner and outer wefts. Yet, the inner and outer surfaces of the tubular liner are connected in a single structure, by a middle layer of warps interlocking the outer and inner wefts. Such method of weaving a tubular liner comprising separating inner and outer wefts thus provides a single jacket tubular liner that may combine, and increase, specific properties of double jacket and single jacket liners into an integral structure.

A first level formed by the outer wefts and warps, a second level formed by warps indirectly connecting the inner and outer wefts, and a third level formed by the inner wefts and warps, as described hereinabove. In such a three-level integrated structure, the first and third levels are connected through the second level, in which warps indirectly connect the inner and outer wefts (see FIG. 1C for example). By thus separating wefts of upper and lower levels of the structure of the tubular walls, different properties may be selected for the outer wefts and for the inner wefts depending on the respective environment, outside and inside of the tubular liner respectively, they must be resistant to, and different properties may be designed for each level, hence different selected properties for the outer surface and for the inner surface of the tubular liners.

Such levels in the structure of the walls may be extended to more than two levels. Such levels in the structure of the woven tubular liners may be extended to multiple levels. The present disclosure applies for first wefts, second wefts, third wefts, etc. . . . , the first, second and third wefts, etc. . . . , interlocking with warps as opposed to interlocking directly together.

FIG. 5 shows results of elongation tests of tubular liners, where: I is a standard 8″double jacket tubular liner, II is a single jacket tubular liner with resin extrusion, Ill and IV are tubular liners of the present disclosure as discussed in relation to FIG. 3. Elongation is mainly caused by de-interlocking of wefts and warps of the present disclosure up to about 150 psi, and then to stretching of each thread. Elongation of the tubular liners III and IV is reduced compared to known similar tubular liners of same nominal inner diameter and warp materials and density, tested under the same conditions of submitting to increased inner water pressure.

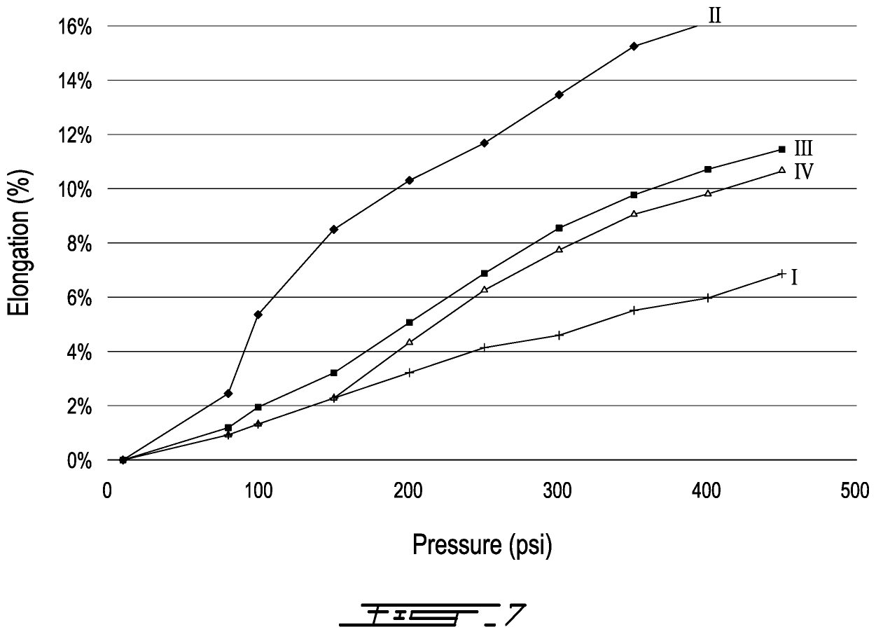

FIG. 6 shows results of burst tests of tubular liners, where: I is a standard 8″double jacket tubular liner, II is a single jacket tubular liner with resin extrusion, Ill and IV are tubular liners of the present disclosure as discussed in relation to FIG. 3. The tubular liners of same nominal inner diameter are submitted to increasing water pressure and the burst pressure is measured as well as the localisation of the damage in the liner, i.e. either the warp C, the wefts T or hose couplings O. In all tests, failure by burst occur in the wefts T. The present tubular liners III, IV may reach pressures at least as high as the double jacket liner I although present tubular liners III, IV are single jacket liners.

FIG. 7 shows longitudinal expansion in % of elongation, as defined as the relative difference expressed in % between the length of the liner at the end of water pressure application and the initial length of the liners, of the same tubular liners I, II, II and IV as in FIG. 6, as a function of inner pressure in psi.

The present tubular liner is made of continuous wires for the warps and wefts, thereby exempt of short lengths of warps and wefts, the lengths of the wires being limited by the spools capacity, thereby splices ensure the continuity of the wires upon changing spools, thereby yielding a seamless, sutureless, jointless woven tubular liner, as opposed to flat weaved tubular liners.

It was found that the present single jacket tubular liners have bursting resistance, flexibility, resistance to temperature variations, radial and longitudinal expansion as well as resistance to puncture, comparable to those of double jacket tubular liners.

The materials, sizes and density of the inner wefts, the outer wefts and the warps may be selected according to target parameters of the tubular liner, so as to reach target combinations of elongation and expansion, abrasion, flexibility and resistance to temperature variations, tailored to each specific application of the tubular liners. For example, in the case of fire hoses or mining hoses, target parameters may include maximized bursting resistance, controlled elongation, resistance to winding, resistance to abrasion, resistance to outer and inner environments.

The internal and external wefts may be high tenacity polyethylene terephthalate (PET) yarns and the warps ultra-high molecular weight polyethylene (UHMPWE) yarns for example.

Textile synthetic wires such as polyester, nylon, technical fibers such as aramid, ultra-high-molecular-weight polyethylene (UHMWPE, UHMW) also known as high-modulus polyethylene (HMPE), mineral fibers such as basalt and glass fibers may be used. Wires of continuous fibers, discontinuous fibers or spun fibers may be used. Coated wires as well as hybrid yarn or combination of technical fibers and yarns may also be used.

The present 3-dimensional weaving method creates thickness by stacking multiple layers.

The scope of the claims should not be limited by the embodiments set forth in the examples, but should be given the broadest interpretation consistent with the description as a whole.

1. A woven tubular liner, comprising an outer surface and an inner surface, wherein the outer surface comprises outer wefts and warps, and the inner surface comprises inner wefts and the warps, the inner and outer surfaces being connected by the warps, the outer wefts being protected from an environment inside of the tubular linear and the inner wefts being protected from an environment outside of the tubular liner.

2. The tubular liner of claim 1, wherein the outer wefts and the warps form a first level, the warps indirectly connecting the inner and the outer wefts form a second level, and the inner wefts and the warps form a third level, yielding a three-level integrated structure.

3. The tubular liner of claim 1, wherein the outer wefts and the warps form a first level, and the inner wefts and the warps form a second level, the inner wefts in the first level and the outer wefts in the second level being indirectly connected by the wraps.

4. The tubular liner of claim 1, wherein the outer wefts and the warps form an outer level, the warps indirectly connecting the inner and the outer wefts in a middle level, and the inner wefts and the warps form an inner level, yielding a three-level integrated structure, the outer wefts and the inner wefts being separated by the middle level in the structure.

5. The tubular liner of claim 1, wherein the outer wefts have first properties and the inner wefts have second properties, said first properties being selected according to the environment outside of the tubular liner and said second properties being selected according to the environment inside of the tubular liner.

6. The tubular liner of claim 1, wherein the outer surface has first properties and the inner surface has second properties.

7. The tubular liner of claim 1, wherein the inner wefts, the outer wefts and the warps are made in materials, sizes and density selected according to target parameters of the tubular liner.

8. The tubular liner of claim 1, wherein at least one of: the inner wefts and the outer wefts comprises polyethylene terephthalate yarns and the warps comprise ultra-high molecular weight polyethylene yarns.

9. The tubular liner of claim 1, wherein at least one of: the inner wefts, the outer wefts and the warps comprise ones of: textile synthetic wires, technical fibers, ultra-high-molecular-weight polyethylene fibers and mineral fibers.

10. The tubular liner of claim 1, wherein at least one of: the inner wefts, the outer wefts and the warps comprises ones of: continuous fibers, discontinuous fibers and spun fibers.

11. The tubular liner of claim 1, wherein at least one of: the inner wefts, the outer wefts and the warps comprises one of: coated wires, hybrid yarns and combination of technical fibers and yarns.

12. A tubular liner weaved of continuous warps and continuous wefts, comprising at least i) first wefts interlaced with the warps and ii) second wefts interlaced with the warps, the first wefts and the second wefts being connected by the warps, and the first and the second wefts being separated.

13. A method of weaving a tubular liner, comprising repeating a weaving unit of continuous outer wefts and continuous inner wefts running uninterrupted along a circumferential direction, woven with continuous warps running along a longitudinal direction, offsetting positions of the warps relative to the wefts in the weaving unit, selectively interlacing outer wefts with the warps, and selectively interlacing inner wefts with the warps.

14. The method of claim 13, wherein the outer wefts and the inner wefts are separated in a thickness of the tubular liner.

15. The method of claim 13, comprising separating the outer and the inner wefts of the weave by the warps, yielding an inner surface of the tubular liner formed by the inner wefts interlocked with the warps, and an outer surface of the tubular liner formed by the outer wefts interlocked with the warps.
